(19) United States
(12) Patent Application Publication
(10) Pub. No.: US 2026/0199806 A1
(43) Pub. Date: Jul. 16, 2026

(54) MICROWAVE APPARATUS FOR EXTRACTION OF VOLATILES

(71) Applicant: Firmenich SA, Satigny (CH)

(72) Inventors: Sophie LAVOINE HANNEGUELLE, Grasse (FR); Joao CABRAL DA SILVA, Grasse (FR)

(21) Appl. No.: 19/137,783

(22) PCT Filed: Dec. 18, 2023
(86) PCT No.: PCT/EP2023/086324

§ 371 Date: Jun. 11, 2025

(30) Foreign Application Priority Data
Dec. 19, 2022 (EP) 22214562.5

(51) Int. Cl. B01D 11/02; H05B 6/76; H05B 6/78; H05B 6/80

(52) U.S. Cl. CPC B01D 11/0211; B01D 11/023; H05B 6/76; H05B 6/78; H05B 6/806

(57) ABSTRACT

An apparatus for extracting liquid composition from organic material including:
(i) a microwave (MW) cavity including:
a MW extraction chamber having an inlet opening and an outlet opening for the organic material and a collecting opening at its bottom for collecting liquid compositions,
a microwave generation chamber, separated from the MW extraction chamber
(ii) at least one microwave generator, arranged to heat the organic material in the MW extraction chamber;
(iii) an inlet tunnel opening into the inlet opening of the MW extraction chamber and an outlet tunnel extending from an outlet opening of the MW extraction chamber, and
(iv) conveyor means for transporting organic material through the inlet tunnel, the MW extraction chamber and the outlet tunnel.

### TECHNICAL FIELD

The present invention relates to the field of Perfumery, Flavors and ingredients for Industry. More particularly, it concerns the microwave assisted extraction of extracts for manufacturing or formulating perfuming, flavor and/or industrial ingredients.

### BACKGROUND

Microwave (MW) extraction represents an ecofriendly advantageous way of extracting compounds from natural biomasses without the use of a solvent. It is particularly advantageous for extracting volatiles and food grade compositions.

For industrial applications, continuous MW extraction is usually preferred to batch-wise processing.

Unfortunately, existing continuous microwaves extraction devices for solid/liquid do not provide to the operators and/or surrounding other workers safe conditions of extraction. Indeed, human body is mainly composed of water and is particularly sensitive to microwaves, notably the brain, lungs, heart or eyes. It is essential to limit the level of exposition of the human body to a Specific Absorption Rate (SAR) average for the whole body of less than 0.4 W/kg and should not exceed a power density of 50 W/m² (5 mW/cm²) for industrial microwave ovens which operate at a frequency band of 2450 MHz (directive 2004/40/EC; ICNIRP, 1998).

The usual way of protecting operators is to provide them with some Personal Protective Equipment or to reduce their time of exposure to microwaves when device is running.

There is a need to provide safer conditions of work for industrial scale extraction using microwaves equipment.

Operators face also the risk of burns due to the increase of temperature of the equipment. Not only it exposes worker for burning but also creates hot spots within raw materials reducing the quality of extraction. Indeed, uniformity of treatment of the raw material is also a challenge during microwave extraction. The hot spots can burn the raw material generating off notes and reducing quality of the extraction.

The other main issue related to increase in temperature of the equipment is that it limits its duration of work, typically in existing microwave extraction devices, the extraction line should be stopped regularly in order to reduce in temperature of the device. It is a strong limitation in term of productivity.

There is a need to have a microwave equipment that provides safer conditions of work to operators but also provides a continuous extraction process with a uniform treatment of the raw material.

### SUMMARY OF THE INVENTION

One aspect relates to an apparatus for extracting liquid composition from organic material, comprising:
a MW cavity comprising:
   a MW extraction chamber having an inlet opening and an outlet opening for the organic material and a collecting opening at its bottom for collecting liquid compositions,
   a microwave generation chamber separated from the MW extraction chamber,
   at least one microwave generator, arranged to heat the organic material in the MW extraction chamber;
   an inlet tunnel opening into the inlet opening of the MW extraction chamber and an outlet tunnel extending from an outlet opening of the MW extraction chamber,
   conveyor means for transporting organic material through the inlet tunnel, the MW extraction chamber and the outlet tunnel.

The MW cavity, in particular the microwave generation chamber, may comprise the at least one microwave generator.

The at least one microwave generator may be arranged outside of the MW cavity.

The at least one microwave generator may be connected to the microwave generation chamber via at least one wave guide.

In an embodiment, at least part of the inlet tunnel and/or at least part of the outlet tunnel is/are arranged outside of the MW cavity. In other words, it is preferred that the MW cavity does not comprise, or contain, at least part of the inlet tunnel and/or at least part of the outlet tunnel.

In an embodiment, the conveyor means extends into and out of the MW cavity. Thus, the MW cavity does not comprise, or contain, the full conveyor means.

The conveyor means may extend along a path, wherein only a part of this path extends within the MW cavity. The remainder of the path may extend laterally of, and/or below, the MW cavity.

At least the outlet tunnel may be provided with cooling means cooling at least partially the walls of the outlet tunnel.

The outlet tunnel may be arranged such that liquid condensing in the outlet tunnel is made to flow towards the bottom of the MW extraction chamber.

The inlet tunnel and/or the outlet tunnel may comprise at least one microwave trap. The microwave trap may extend along, and/or cover, at least 10%, or at least 25%, or at least 50%, or at least 75%, or at least 90%, or 100%, of the longitudinal extension of the inlet tunnel, wherein the longitudinal extension is preferably parallel to the extension and/or transporting direction of the conveyor means within the inlet tunnel.

The microwave trap may extend along, and/or cover, at least 10%, or at least 25%, or at least 50%, or at least 75%, or at least 90%, or 100%, of the longitudinal extension of the outlet tunnel, wherein the longitudinal extension is preferably parallel to the extension and/or transporting direction of the conveyor means within the outlet tunnel.

The microwave trap may be an absorbent, a reactive or a hybrid microwave trap.

The inlet tunnel and/or the outlet tunnel may comprise two microwave traps, the microwave trap closer to the MW extraction chamber being a reactive trap, preferably, the microwave trap further to the MW extraction chamber being an absorbent trap.

A microwave transparent cover may hermetically separate the MW extraction chamber from the microwave chamber.

The apparatus may comprise means for reducing pressure in the MW extraction chamber and guiding the vapours to a condenser to condensate the vapours generated.

Said means for reducing pressure may be arranged such that a pressure below the conveyor means is reduced, e.g. such that below the conveyor means a vacuum is provided. Thereby (i.e. by the pressure differential), a (e.g. downward) flow through the conveyor means and/or towards the collecting opening and/or the bottom of the MW extraction chamber can be provided, e.g. for collecting liquid compositions in the form of a liquid and/or vapour.

The means for reducing pressure may be the condenser.

Organic material arranged on the conveyor means may be heated by the at least one microwave generator from above (e.g., the at least one microwave generator is arranged above the conveyor means), wherein, optionally, on the opposite side of the conveyor means, i.e. below the conveyor means, the pressure may be reduced.

By heating the organic material on the conveyor means, a pressure in the MW extraction chamber may be increased, which may aid in guiding the vapours to the condenser to condensate the vapours generated. For instance, a pressure may be increased above the conveyor means. By this, and by a lower pressure below the conveyor means (which lower pressure may be reduced by using said means for reducing pressure), a (e.g. downward) flow through the conveyor means and/or towards the collecting opening and/or the bottom of the MW extraction chamber can be provided, e.g. for collecting liquid compositions in the form of a liquid and/or vapour.

The conveyor means comprises a conveyor belt having a longitudinal axis that may have at least inside the MW extraction chamber and the outlet tunnel, an inclination of between 0.5 to 60 degrees from the horizontal plan.

Steam nozzles in the MW extraction chamber are preferably arranged on the side walls of the MW extraction chamber above or close to the conveyor belt.

The bottom of the inlet tunnel and/or the outlet tunnel may be arranged on a higher level than the bottom of the MW extraction chamber, preferably via step.

The inlet tunnel may comprise a top wall and/or a bottom wall, wherein from each of the top wall and/or the bottom wall one or more side walls extend. Optionally, the one or more sidewalls extend from the top wall to the bottom wall. Accordingly, the top wall and/or the bottom wall on the one hand and the one or more side walls on the other hand delimit a passage, wherein the conveyor means extends through the passage.

At least part of the microwave trap of the inlet tunnel may be arranged i) in the top and/or bottom wall(s), and/or ii) in the one or more side walls. At least part of the microwave trap may be arranged in the top wall. At least part of the microwave trap may be arranged in the bottom wall. At least part of the microwave trap may be arranged in the one or more side walls.

The outlet tunnel may comprise a top wall and/or a bottom wall, wherein from each of the top wall and/or the bottom wall one or more side walls extend. Optionally, the one or more sidewalls extend from the top wall to the bottom wall. Accordingly, the top wall and/or the bottom wall on the one hand and the one or more side walls on the other hand delimit a passage, wherein the conveyor means extends through the passage.

At least part of the microwave trap of the outlet tunnel may be arranged i) in the top and/or bottom wall(s), and/or ii) in the one or more side walls. At least part of the microwave trap may be arranged in the top wall. At least part of the microwave trap may be arranged in the bottom wall. At least part of the microwave trap may be arranged in the one or more side walls.

Optionally, each of the tunnels may completely surround the conveyor means, such as the conveyor belt. In other words, each of the tunnels may completely surround a respective part of the path along which the conveyor means extends.

The apparatus may have an external housing. The external housing is arranged to ensure reduction of loss of volatiles and/or to ensure reduction of the loss of microwaves, i.e. to shield microwaves. The external housing may contain, or house, the MW extraction chamber, the inlet tunnel, the outlet tunnel and/or the conveyor means.

The apparatus may have an input end and an output end, wherein via the input end the conveyor means may be loaded, and wherein via the output end the conveyor means may be unloaded. The input end may be provided by the external housing. The output end may be provided by the external housing.

The MW cavity, in particular the MW extraction chamber and the microwave generation chamber, may contain one or more parts that are all microwave transparent. This achieves the advantage that hot spots in the MW cavity are reduced and that a uniform microwave field is provided. Further, a reduction of microwave-non-transparent material is achieved. The one or more parts may comprise conveyor rollers of the conveyor means, nozzles (such as steam nozzles), and/or a handling structure (such as a handgrip). In an embodiment, all (machine) parts arranged within the MW cavity are microwave transparent.

In sum, the apparatus in particular achieves the following advantages:
a particularly good extraction of liquids from the raw materials through the conveyor means or by condensation of the vapor, wherein the liquids may be used for products to be used as flavors and/or fragrances;
avoiding the loss of vapor, in particular by the means for reducing pressure, the transparent cover and/or the external housing to ensure reduction of loss of volatiles;
avoiding the loss of microwaves, in particular by the inlet and/or outlet tunnel/s preferably with microwave traps, and/or the external housing, which may at least help in avoiding such a loss;
reduction of hot spots in the MW cavity and a particularly uniform microwave field, which may be increased by using materials within the cavity (extraction chamber and/or generation chamber) that are made of a microwave-transparent material, such as the materials of the conveyor rollers, the nozzles, handgrip, etc. ;
reduction of microwave-non-transparent materials.

Another aspect relates to a method of extracting liquid composition from an organic material, comprising the steps of:
(a) introducing the organic material into a central chamber, the chamber being arranged to receive microwave radiations from at least one microwave generator;
(b) reducing pressure in the MW extraction chamber to a pressure less than atmospheric pressure;
(c) optionally spraying steam on the organic material
(d) collecting steam to be condensed by a condenser and collecting liquids generated from the MW extraction chamber and from the condenser in a collecting tank
(e) removing the treated organic material from the central chamber.

Yet another aspect relates to a method for extracting a liquid composition from an organic material, by using an apparatus as explained above.

The method may comprise the step of increasing pressure in the central chamber (i.e. the MW extraction chamber) to a pressure higher than atmospheric pressure. The pressure may be increased in a section that is different from a section where the pressure is reduced. For instance, the central chamber may be divided, e.g. by a conveyor means, into an upper section and a lower section, wherein in the upper section the organic material is arranged to receive the microwave radiations, and wherein in the upper section the pressure is increased and in the lower section the pressure is reduced, e.g. to provide a vacuum. This results in a (e.g. downward) flow from the upper section into the lower section, e.g. through the conveyor means, for collecting steam and/or liquids.

Reducing pressure may result in that a pressure below the organic material in the central chamber is reduced, e.g. such that below this organic material a vacuum is provided. Thereby (i.e. by the pressure differential), a (e.g. downward) flow through a conveyor means transporting the organic material and/or towards the condenser and/or a bottom of the MW extraction chamber can be provided, e.g. for collecting liquid compositions in the form of a liquid and/or vapour in the collecting tank.

The means for reducing pressure may be the condenser.

Organic material in the central chamber, e.g. arranged on the conveyor means, may be heated by the microwave radiation from above (e.g., the at least one microwave generator is arranged above the conveyor means and/or the organic material in the central chamber), wherein, optionally, on the opposite side of the organic material and/or conveyor means, i.e. below the organic material and/or the conveyor means, the pressure may be reduced.

By heating the organic material in the central chamber and preferably on the conveyor means, a pressure in the central chamber may be increased, which may aid in guiding the vapours to the condenser to condensate the vapours or steam generated. For instance, a pressure may be increased above the organic material and/or the conveyor means. By this, and by a lower pressure below the organic material and/or conveyor means (which lower pressure may be reduced by using said means for reducing pressure), a (e.g. downward) flow through the conveyor means and/or towards the condenser and/or collecting tank and/or the bottom of the MW extraction chamber can be provided, e.g. for collecting liquid compositions in the form of a liquid and/or vapour in the collecting tank.

An aspect relates to an apparatus for extracting liquid composition from organic material, comprising:
(i) a MW cavity comprising:
   a MW extraction chamber having an inlet opening and an outlet opening for the organic material and a collecting opening at its bottom for collecting liquid compositions,
   a microwave generation chamber separated from the MW extraction chamber,
(ii) at least one microwave generator, arranged to heat the organic material in the MW extraction chamber;
(iii) an inlet tunnel opening into the inlet opening of the MW extraction chamber and an outlet tunnel extending from an outlet opening of the MW extraction chamber,
(iv) conveyor means for transporting organic material through the inlet tunnel, the MW extraction chamber and the outlet tunnel.

### DESCRIPTION OF THE INVENTION

### BRIEF DESCRIPTION OF THE DRAWINGS

FIG. 1 is a longitudinal cutaway of one embodiment of the apparatus.

FIG. 2 is a longitudinal cutaway of a second embodiment of the apparatus.

FIG. 3 is a longitudinal cutaway of a third embodiment of the apparatus.

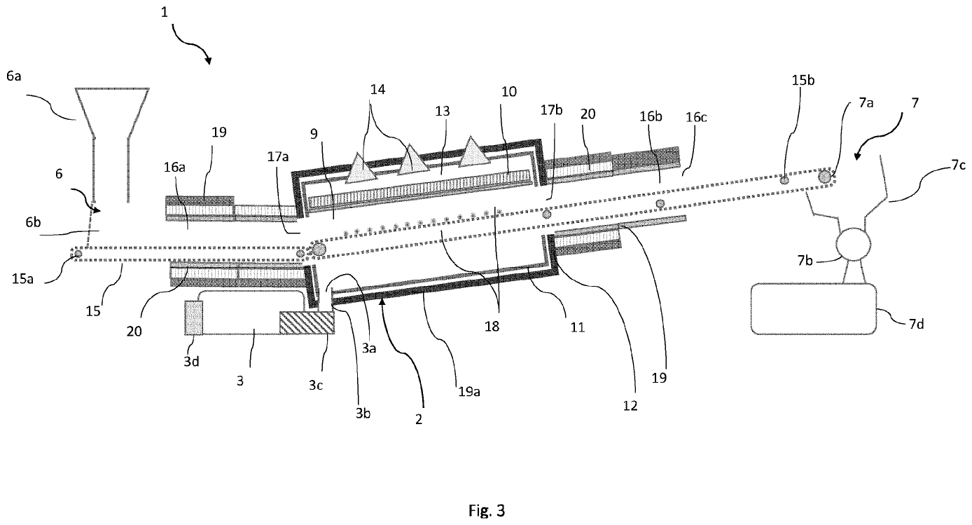

### DESCRIPTION OF THE PREFERRED EMBODIMENTS

Throughout the following description and the drawings, in which corresponding and like parts are identified by the same reference characters, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The extraction apparatus 1 comprises a MW cavity 2, in which organic material is heated by microwaves generated by one or more microwave generators 14, to release substances from the organic material and extract a liquid composition comprising said substances. The liquid composition is then made to leave the MW cavity 2 and is then collected in a collecting tank 3.

The apparatus 1 has an input end 4 and an output end 5 of the travel path for the organic material through the apparatus, with a raw organic material loading module 6 at the input end 4 and a treated organic material unloading module 7 at the output end 5. According to one embodiment the apparatus 1 has an external housing 8 on a supporting frame (not represented).

A two-side opened MW extraction chamber 9 extends axially into inlet and outlet tunnels 16a and 16b respectively at its inlet and outlet openings 17a and 17b. A microwave-transparent cover 10, made of a microwave-transparent material, forms a ceiling inside the MW extraction chamber 9.

According to the invention a microwave-transparent material such as in microwave transparent cover or microwave transparent layer or microwave transparent conveyor means comprises 1,2-polybutadiene (PBD, 1,2-polybutadiene), polyisoprene, polybutadiene-polyisoprene copolymers, polyetherimide (PEI, polyetherimide), polytetra Fluoropolymers such as fluoroethylene (PTFE, polytetrafluoroethylene), polyimide, polyetheretherketone (PEEK, polyetheretherketone), polyamidimide, polyethylene terephthalate (PET, polyethylene terephthalate), Polyethylene naphtholate, polycyclohexylene terephthalate, polybutadiene-polyisoprene copolymers, polyphenylene ethers, alkylated polyphenylene ethers polymers based on polyphenylene ethers) or combinations thereof. Combinations of high and low polarity may be used, including epoxy and poly(phenylene ether), epoxy and poly(ether imide), cyanate Non-limiting examples including esters and poly(phenylene ether) {cyanate ester and poly(phenylene ether)} and 1,2-polybutadiene and polyethylene may be used. Preferably the microwave transparent layer comprises PEEK and/or PTFE (PEEK/PTFE-5).

The MW extraction chamber 9 has a bottom 11, which might be inclined relative to the horizontal plane, with a collecting duct opening 3a, preferably arranged close to a side wall 12 of the MW extraction chamber 9 for collecting the liquids, preferably the lower end of the bottom 11 of the MW extraction chamber 9 if inclined. The side walls 12 are provided with openings, having essentially the size of the inlet and outlet tunnel, to communicate with the inlet and outlet tunnels 16a and 16b respectively. Typically, the internal face of the side walls 12 and of the bottom 11 of the MW extraction chamber 9 comprise a material reflecting the microwaves, such as metal typically copper, steel, aluminium, lead tin, zinc, brass, gold or silver.

The bottom at least of the MW extraction chamber and/or the outlet tunnel may be horizontal or preferably inclined, and preferably plane.

The longitudinal extension of each of the inlet tunnel and/or the outlet tunnel preferably is/are at least 20%, preferably at least 40%, more preferred at least 60% of the extension, such as of the longitudinal extension, of the MW cavity.

The longitudinal extension may be the extension parallel to the extension and/or transporting direction of the conveyor means within the inlet tunnel, the MW extraction chamber and/or the outlet tunnel.

The longitudinal extension of the inlet tunnel preferably is at least 200%, preferably at least 400%, more preferred at least 600% of the diameter of the inlet opening in a side wall of the MW cavity. The longitudinal extension of the outlet tunnel preferably is at least 200%, preferably at least 400%, more preferred at least 600% of the diameter of the outlet opening in a side wall of the MW cavity.

The longitudinal extension of each of the inlet tunnel and/or the outlet tunnel preferably is/are at least 200%, preferably at least 400%, more preferred at least 600% of the average diameter, of the inlet and outlet openings in the side walls of the MW cavity.

The longitudinal extension of each of the inlet tunnel and/or the outlet tunnel preferably is/are less than 150%, preferably less than 100%, more preferred less than 80% of the extension, such as of the longitudinal extension, of the MW cavity.

The cross-sectional surface of the inlet and/or the outlet tunnel is preferably smaller than the cross-sectional surface of the MW cavity, preferably by at least 20% or at least 40%. Each of the cross-sectional surfaces may extend perpendicularly relative to the respective longitudinal extension and/or the transporting direction of the conveyor means, along which direction the conveyor means transports the organic material through the inlet tunnel, the MW extraction chamber and the outlet tunnel.

Preferably the inlet tunnel and the outlet tunnel are extending centrally and axially to the microwave cavity. The conveyor belt 15 is arranged in the lower halves of these tunnels.

The cross-sectional shape of the inlet tunnel and the outlet tunnel may be rounded or preferably rectangular.

A microwave generation chamber 13 is arranged above the microwave-transparent cover 10 and the microwave extraction chamber 9. The microwave generation chamber 13 a) contains one or preferably several microwave generators 14 producing microwave radiation traversing the MW transparent cover 10 separating the microwave generation chamber 13 and the MW extraction chamber 9, or b) is connected to, or contains at least part of each of, one or preferably several wave guides connected to the one or preferably several microwave generators 14, respectively, that may be arranged outside of the microwave generation chamber 13. The microwave transparent cover 10 hermetically separates the MW extraction chamber from the microwave chamber such that e.g., neither vapor nor any volatiles can leak from the MW extraction chamber 9 into the microwave generation chamber 13. The microwave generation chamber 13 is sealed from the MW extraction chamber 9 but not from the atmosphere and is thus air-filled and at atmospheric pressure. A preferably motor-driven microwave stirrer (not shown) is provided in the microwave generation chamber 13 for dispersing the generated microwaves to facilitate uniform microwave distribution within the MW extraction chamber 9. Typical microwave stirrer includes a motor with output shaft; and agitating blades having a holding portion connected to the output shaft in the middle, and a wing is extended radially outward. The teaching of EP1566986B1 is incorporated by reference as to a possible implementation of such MW stirrer.

Conveyor means comprise at least one conveyor belt 15, conveyor rollers 15a, 15b, 7a for guiding and supporting the conveyor belt(s) and conveyor drive control systems needed for continuously transporting the organic material to be extracted from the loading module 6 through the inlet tunnel 16a to the MW cavity 2, the MW extraction chamber 9 and the outlet tunnel 16b at a controlled speed. In the MW extraction chamber 9, the conveyor belt 15 extends essentially in parallel to the cover 10 and such that organic material loaded on the top side of the conveyor belt 15 is close or even in direct contact with the cover 10. The conveyor belt 15 extends into the loading and unloading modules 6, 7, as described below, and forms a continuous loop, for example by running below the MW cavity 2 and the inlet and outlet tunnels 16a, 16b. The conveyor belt 15 is made to be permeable to liquids extracted from the raw material, e.g., by having pores or other openings or structural features retaining the processed organic materials but allowing a draining of liquid by gravity. Typically, the conveyor belt may comprise pores with an average diameter (d) of 0.001 to 30 millimeters, preferably, 0.01 to 20 mm. During the MW heating extraction process, the organic material remains on the conveyor belt while liquid is drained off the organic material and arriving at the bottom of the MW extraction chamber 9.

The path of the conveyor belt 15 may be inclined, preferably upwards in the travel direction, at least inside the MW extraction chamber and/or the outlet tunnel. The inclination in these sections may be the same or may differ. Preferably the non-zero inclination is the essentially the same in the inlet tunnel, the MW extraction chamber and the outlet tunnel.

The MW extraction chamber 9 comprises at least one steam nozzle(s). To facilitate the extraction of soluble compounds from the organic material, water steam is injected into the MW extraction chamber 9 by nozzles 18 preferably arranged in one or both of otherwise closed lateral wall(s) (which are arranged perpendicular to the open side walls) of the MW extraction chamber 9 and below the cover 10, preferably essentially at the level of the organic material above the conveyor belt 15. Some nozzles can be arranged below the level of the conveyor belt 15. The addition of steam is of particular interest when extracting compounds from dried biomasses or biomasses having a reduced level of water such as seeds or berries or spices.

The loading module 6 has a raw organic material feed distributor, such as a hopper, 6a positioned above the conveyor belt 15 and configured to drop raw organic material to be treated onto the conveyor belt 15. The conveyor belt 15 runs over the conveyor rollers 15a in the loading module 6. Advantageously conveyor rollers are made or embedded into a microwave transparent material.

A raw material supply tank (not represented) is connected via a feed conduit to the raw material feed distributor 6a. A feed controller can be provided to control the flow of raw material into the distributor. The supply tank is at atmospheric pressure. A raw material is generally a solid organic material such as biomass fruits, flowers, leaves, seeds or and thus in the form of pieces that may be loaded on the conveyor belt 15 by a conduit, auger or other transfer device capable of transporting material into the conveyor belt 15.

The inlet tunnel 16a opening to the inlet 17a of the MW extraction chamber 9 is particularly advantageous in that the organic material is packed or thicken within the light of the tunnel before reaching the MW extraction chamber 9 and reduces the leak of microwaves outside the MW cavity 2. The inlet tunnel 16a may have a height lower than the height of the MW extraction chamber 9 and the outlet tunnel.

To avoid loss of steam and thus of volatiles extracted from the raw material, the loading module 6 and notably the feed distributor 6a can be sealed to the supply tank. The interior of the loading module is opened to the MW cavity 2 and is accordingly at reduced pressure during operation of the apparatus. A viewing window (not represented) in the external housing 8 permits visual inspection into the loading module 6 and thus the MW extraction chamber 9.

The outlet tunnel 16b extends from the outlet opening17b of the MW extraction chamber 9 to facilitate cooling of the treated organic material and finalize the extraction of the remaining volatiles before reaching the unloading module 7.

The bottom of the outlet tunnel 16b is preferably inclined towards the MW cavity 2 and is preferably arranged on a higher level, preferably with a step downwards, to the bottom of the MW cavity 2 to promote the flow of condensed liquid back into the MW cavity 2 and the outlet opening 17b arranged in its bottom. To facilitate the flow of liquids from the walls of the outlet tunnel 16b to the MW extraction chamber 9, the central axis of the MW cavity 2 and thus the outlet tunnel 16 b is inclined from 0.5 et 40 degrees from the ground, preferably 2 to 10 degrees.

The outlet tunnel 16b may be provided with its own outlet duct (not shown) in its bottom, which may communicate to a tank, such as e.g., the collecting tank 3 with is in fluid connection with the collection duct 3b in the bottom of the MW extraction chamber 9.

Advantageously, to accelerate the cooling of the raw material and the condensation of volatiles on the side walls of the outlet tunnel 16b, a cooling system 19 is provided e.g., within the side walls and or ceiling and/or bottom of the outlet tunnel 16b.

The inlet and outlet tunnels 16a, 16b also reduce the level of microwaves escaping from the MW extraction chamber 9. In order to further promote the reduction of leakage of microwaves from the MW extraction chamber 9, microwaves traps 20 are arranged within at least the outlet tunnel and preferably within both the inlet and outlet tunnels 16a and 16b. Typically the microwave trap 20 is an absorbent trap, a reactive or a hybrid trap, preferably the microwave trap 20 is a hybrid trap.

Reactive traps are characterized by the presence of a set of metal parts, generally cylinders, arranged in such a way as to attenuate wave leaks. The number of metal parts, their height, diameter and positioning are linked to the geometry of each piece of equipment.

Absorbent traps adapted to the invention have the characteristics of a microwave absorber plate. Typically, microwave absorber plates are dielectrically heated by microwave leaks and are advantageously combined cooling system 19. Absorbent traps according to the invention comprise a metallic or mineral powder selected from ferrite powder, carborundum powder, alumina powder, calcium oxide powder, magnesia powder, titanium oxide powder, zirconia powder, silica powder, kaolin, feldspar, gypsum, graphite or a combination thereof. The metallic or mineral powder has an average diameter of 5 to 100 μm. Typically, the absorbent trap comprises a mix of metallic or mineral powder with an insulating material, advantageously a mix of a metallic powder and an insulating material. The insulating material is a natural or a synthetic polymer typically rubber, the metallic powder is ferrite powder.

According to another embodiment, the absorbent trap is the cooling system 19 comprising a network of pipes, typically polymer pipes (e.g., polyvinyl chloride) transporting an absorbent liquid advantageously water.

Advantageously the trap system is a hybrid trap. The hybrid trap being a mix of a reactive trap and an absorbent trap.

Examples of reactive, absorbent or hybrid traps suitable for the present invention are described in CN202282884, CN214481362, CN102752892 or U.S. Pat. No. 4,182,946.

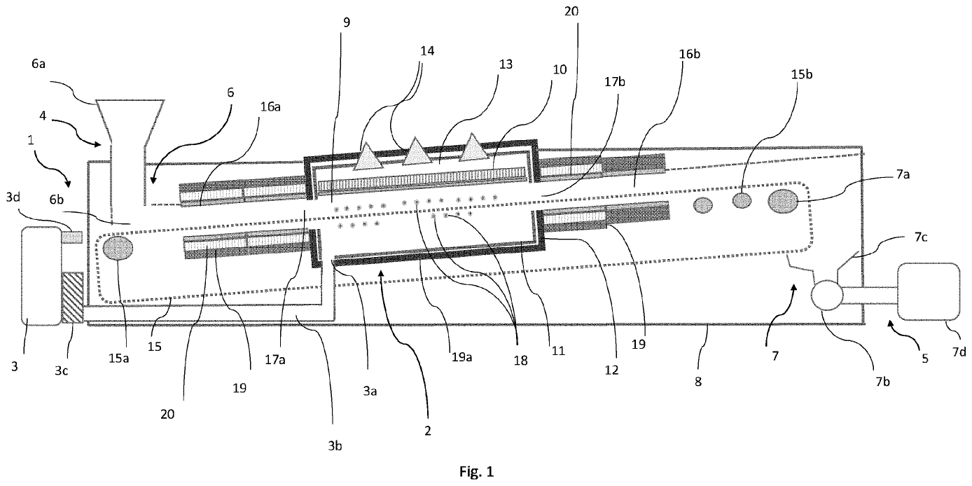

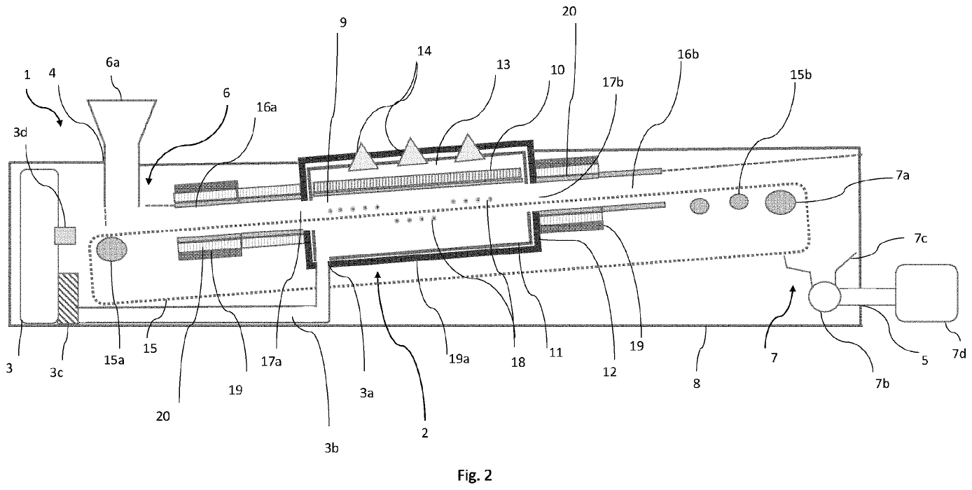

According to a first embodiment of the tunnels (represented for the inlet tunnel on FIGS. 1 and 2), a reactive trap is arranged at a first portion of the tunnel adjacent to the MW extraction chamber 9 and an absorbent microwave trap is arranged at the second portion of the tunnel away from the MW extraction chamber 9. According to this embodiment, the cooling system may be limited to the portion of the outlet tunnel away from the MW cavity (represented for the inlet tunnel on FIG. 1) or the cooling system can be added all along the outlet tunnel (represented for the inlet tunnel on FIG. 1). According to another embodiment, the microwave trap can be arranged in the tunnel at the portion closest to the central chamber. Similarly, according to this second embodiment, the cooling system can be arranged only on the outside walls of the tunnel having the microwave trap (represented for the outlet tunnel on FIG. 2) or all along the tunnel (represented for outlet tunnel on FIG. 1). According to another embodiment, the cooling system is arranged on the external walls of the tunnel(s) except at the bottom of the tunnel(s).

The trapping of the microwave escaping from the MW extraction chamber 9 due to the microwave traps 20 of the inlet and outlet tunnels 16a and 16b is that effective that the external housing 8 of the apparatus is optional as to its MW shielding. Nevertheless, depending on the raw material for safety, microbiological and yield of extraction reasons this external housing 8 remains very advantageous.

According to another embodiment the MW cavity 2 comprises doors (not shown) preferably sliding doors at the inlet 17a and outlet 17b of the MW extraction chamber 9. Such doors are advantageous for working in batch mode.

Advantageously, the central axis of the conveyor belt is inclined in order to facilitate the flow of liquids form the treated raw material all along the conveyor belt to the MW extraction chamber 9. Typically, the conveyor belt may be inclined at least within the MW extraction chamber 9, preferably at least from the inlet 17a of the MW extraction chamber 9 to the opening 16c of the outlet tunnel 16b, optionally from the inlet 17a of the MW extraction chamber 9 to the unloading module 7. Some means may be arranged to stop the liquid flowing along the belt to go beyond the inlet opening 17a of the MW extraction chamber 9. E.g., the bottom of the inlet tunnel is arranged on a higher level than the bottom of the MW extraction chamber 9. Typically, the axis of the conveyor belt is inclined from 0.5 et 60 degrees from the ground, preferably 2 to 10 degrees.

Due to the gravity draining of liquid extracts from the organic material through the conveyor belt 15 on the bottom of the MW extraction chamber 9, it is particularly advantageous that the conveyor belt 15 forms a continuous loop extending below the MW cavity 2. Nevertheless, another continuous loop can be envisaged laterally to the MW cavity or within the MW cavity. A collecting system can be envisaged to scrape the surfaces of the belt free of raw material before exiting the MW extraction chamber 9. It is also particularly advantageous that a cooling system 19a is arranged within the walls of the MW cavity to maintain the liquid extracts into liquid forms and facilitate its collection to the collecting duct 3a. A cooling system 19a is also particularly advantageous for a continuous operation of the apparatus.

As the raw organic material is in close contact with the upper walls of respectively, the inlet tunnel 16a, the cover 10 of the MW extraction chamber 9 and the outlet tunnel 16b, said upper walls are advantageously protected by a microwave transparent layer comprising a material that is heat resistant.

The unloading module 7 has conveyor rollers 7a for guiding the conveyor belt 15. A material collector 7c is positioned under the outward roller to receive treated material coming from the outlet tunnel 16b and dropping from the conveyor belt 15. A drive roller(s) 7a, rotated by a motor (not represented), drives the conveyor belt 15. The unloading module 7 is included into the apparatus and surrounded by the external housing 8 (FIGS. 1 and 2), fastened and sealed to the output end 5 of the apparatus 1; a viewing window (not represented) maybe arranged to permit visual inspection into the unloading module. The unloading module is open to the MW extraction chamber 9 via the outlet tunnel 16b and is thus at reduced pressure during operation of the apparatus.

Optionally, an auger conveyor 7b is positioned under the material collector 7c and receives the treated material from it. A vacuum seal between the lower end of the material collector 7c and the auger conveyor 7b maintains the vacuum within the MW extraction chamber 9 and auger conveyor 7b. The auger 7b is driven by a motor (not represented). Outlet valves (not represented) at one end of the auger conveyor 7b can be positioned to provide for removal of the treated material from the apparatus 1. Such valves would function as an airlock to permit the removal of treated product. The container (7d) advantageously vacuum-sealed receives the treated product are attached to the valves. One valve is open at a time to permit one container 7d to receive product from the auger 7b, while the other valve is closed to permit removal of a filled container from that valve. The two valves are opened and closed alternately to permit the auger 7b to run continuously.

A cooling system may also be provided around the collection duct 3b and the tank 3.

A pump 3d is connected to the tank 3 in order to suck the steam generated in the MW extraction chamber 9 to the collecting duct 3b. The tank may thus be at reduced pressure relative to the MW extraction chamber. Ideally a condenser is arranged upfront the vacuum pump 3d. The collecting duct 3 b is connected to the condenser 3 c which in turn connects to the tank 3 in which all liquids extracted from the raw materials are stored.

The steam sucked from the MW extraction chamber 9 is condensed by the condenser 3c and the liquids obtained stored in the tank 3.

The vacuum pump 3d reduces the pressure within the apparatus 1 or at least in the MW extraction chamber 9 below the atmospheric pressure, preferably between 0.99 and 0.001316 atm even more preferably 0.55 atm and 0.01316 atm. This difference in pressure is particularly advantageous in that it limits the loss of steam and thus volatiles from the apparatus 1 or at least the MW extraction chamber 9. The extraction of the volatiles from the MW extraction chamber also reduces the exposure of the volatiles to heat and thus potential degradation.

Alternatively, the tank 3, the pump 3d and the condenser 3 c can be within the external housing 8 of the apparatus (see FIG. 2).

As mentioned above, the apparatus includes one or several cooling units (not represented) comprising a compressor, cooling fan and refrigerant pump, connected to convey refrigerant via a refrigerant pipe extending along any and or all of the walls of the MW extraction chamber 9, the inlet tunnel 16a, the outlet tunnel 16b, the collecting duct 3b and/or the tank 3.

According to the invention, the apparatus 1 includes a programmable logic controller (PLC), programmed and connected to control the operation of the system, including controlling the inflow of raw material, the motors, the microwave generators, the vacuum pump and the refrigerant pump.

The extraction apparatus 1 operates according to the following method. The refrigerant pump, microwave generators, motors and the raw material feed controller are actuated, all under the control of the PLC. The organic material to be treated is fed onto the conveyor belt 15 and is carried through the inlet tunnel 16a, the inlet opening 17a to the MW extraction chamber 9 below the cover 10. The microwave generators generate microwaves having a median frequency of between 0.3 to 300 GHz, preferably 0.5 to 5.2 GHz; 0.8 to 3 GHz; 0.9 to 2.5 GHz. Typically, the microwave generators are variable-frequency microwave generators. Advantageously, microwave generators generate microwaves having a median frequency of 2450 MHz with a power of between 300 W 6000 W, preferably between 1000 W-3000 W. According to another embodiment, the microwave generators generate microwaves having a median frequency of 915 MHz with a power of between 300 W-6000 W, preferably between 1000 W-3000 W. Processing time may be in the range of 0.1 to 20 Kg/hour, typically between 0.5 and 12 Kg/hour. Typically, processing time may be about 5 min to 2.5 hours preferably between 8 minutes and 2 hours even more preferably 10 minutes to 1 hours. The liquids flow through the conveyor belt 15 to the bottom of the MW extraction chamber 9 and is collected to the collecting opening 3a to be stored in the tank 3. The steam is condensed on the side walls of the MW extraction chamber 9 or the outlet tunnel 16b, flow to the side walls of the MW extraction chamber 9 to the collecting duct opening 3a at the bottom of the MW extraction chamber 9. The extraction of volatiles is enhanced by the radiation and potentiated by the steam sprayed on the raw material by the nozzles 18. The steam sucked from the MW extraction chamber 9 and from the inlet tunnel 16a and/or the outlet tunnel 16b to the collecting duck 3b and condensed by the condenser 3c to be stored on the tank 3. The treated material falls into the material collector 7c, moves into the auger conveyor 7b and is removed from the apparatus through the outlet valve 5.

1. An apparatus for extracting liquid composition from organic material, comprising:
a microwave (MW) cavity comprising:
a MW extraction chamber having an inlet opening and an outlet opening for the organic material and a collecting opening at its bottom for collecting liquid compositions,
a microwave generation chamber, separated from the MW extraction chamber,
at least one microwave generator, arranged to heat the organic material in the MW extraction chamber;
an inlet tunnel opening into the inlet opening of the MW extraction chamber and an outlet tunnel extending from an outlet opening of the MW extraction chamber, and
conveyor means for transporting organic material through the inlet tunnel, the MW extraction chamber and the outlet tunnel.

2. The apparatus according to claim 1, the microwave generation chamber comprising the at least one microwave generator.

3. The apparatus according to claim 1 wherein one, more or all of the outlet tunnel, the MW extraction chamber and a duct connected to the collecting opening is provided with cooling means.

4. The apparatus according to claim 1, wherein the outlet tunnel is arranged such that liquid condensing in the outlet tunnel is made to flow towards the bottom of the MW extraction chamber.

5. The apparatus according to claim 1, wherein the inlet tunnel and/or the outlet tunnel comprise at least one microwave trap.

6. The apparatus according to claim 5, wherein the microwave trap is an absorbent, a reactive, or a hybrid microwave trap.

7. The apparatus according to claim 1, wherein the inlet tunnel and/or the outlet tunnel comprise two microwave traps, the microwave trap closer to the MW extraction chamber being a reactive trap.

8. The apparatus according to claim 1, wherein a microwave transparent cover hermetically separates the MW extraction chamber from the microwave generation chamber.

9. The apparatus according to claim 1, wherein the apparatus comprises means for reducing pressure in the MW extraction chamber and guiding the vapours to a condenser of the apparatus to condensate the vapours generated.

10. The apparatus according to claim 1, wherein the conveyor means comprises a conveyor belt with a longitudinal axis having at least inside the MW extraction chamber and the outlet tunnel an inclination of between 0.5 to 60 degrees from the horizontal plane.

11. The apparatus according to claim 1, wherein the bottom of the MW extraction chamber and/or the outlet tunnel, has/have an inclination of between 0.5 to 60 degrees from the horizontal plane.

12. The apparatus according to claim 1, wherein the MW extraction chamber comprises at least one steam nozzle.

13. The apparatus according to claim 1, wherein the bottom of the inlet tunnel and/or the outlet tunnel are arranged on a higher level than the bottom of the MW extraction chamber.

14. A method of extracting liquid composition from an organic material, comprising the steps of:
(a) introducing the organic material into a microwave (MW) extraction chamber, the MW extraction chamber being arranged to receive microwave radiation from at least one microwave generator;
(b) reducing pressure in the MW extraction chamber to a pressure less than atmospheric pressure;
(c) optionally spraying steam on the organic material;
(d) collecting steam to be condensed by a condenser and collecting liquids generated from the MW extraction chamber and from the condenser in a collecting tank; and
(e) removing the treated organic material from the MW extraction chamber.

15. A method of extracting liquid composition from an organic material, the method comprising using the apparatus according to claim 1.

16. The apparatus according to claim 7, wherein the microwave trap further from the MW extraction chamber is an absorbent trap.

17. The apparatus according to claim 11, wherein the lower end of the inclination is towards the inlet opening of the MW extraction chamber.

18. The apparatus according to claim 12, wherein the at least one steam nozzle is arranged on the side walls of the MW extraction chamber above or close to the conveyor belt.

19. The apparatus according to claim 13, wherein the bottom of the inlet tunnel and/or the outlet tunnel are arranged on a higher level than the bottom of the MW extraction chamber via a step.
